(19) United States
(12) Patent Application Publication
(10) Pub. No.: US 2026/0258268 A1
(43) Pub. Date: Sep. 3, 2026

(54) Ink Jet Ink Set And Ink Jet Recording Method

(71) Applicant: SEIKO EPSON CORPORATION, Tokyo (JP)

(72) Inventor: Ryota IMAI, Shiojiri (JP)

(21) Appl. No.: 19/552,265

(22) Filed: Feb. 27, 2026

(30) Foreign Application Priority Data
Feb. 28, 2025 (JP) 2025-030831

(51) Int. Cl. C09D 11/40; B41M 3/00; C09D 11/037; C09D 11/102; C09D 11/107; C09D 11/322; C09D 11/324; D06P 5/30

(52) U.S. Cl. CPC C09D 11/40; B41M 3/008; C09D 11/037; C09D 11/102; C09D 11/107; C09D 11/322; C09D 11/324; D06P 5/30

(57) ABSTRACT

An ink jet ink set includes a first ink jet ink and a second ink jet ink. The first ink jet ink contains a first pigment containing a black pigment, a first binder resin containing an anionic urethane resin particle, an organic solvent, and water. The first pigment is contained in an amount of 3% by mass or more based on a total amount of the first ink jet ink. The anionic urethane resin particle is contained in an amount of 5% by mass or more based on the total amount of the first ink jet ink. The anionic urethane resin particle is an only resin particle contained in a largest amount in the first binder resin. The second ink jet ink contains a second pigment containing at least one selected from the group consisting of a black pigment and a blue pigment, a second binder resin containing an anionic acrylic resin particle, an organic solvent, and water. The second pigment is contained in an amount of 3% by mass or more based on a total amount of the second ink jet ink. The anionic acrylic resin particle is contained in an amount of 3% by mass or more based on the total amount of the second ink jet ink. The anionic acrylic resin particle is an only resin particle contained in a largest amount in the second binder resin.

The present application is based on, and claims priority from JP Application Serial Number 2025-030831, filed Feb. 28, 2025, the disclosure of which is hereby incorporated by reference herein in its entirety.

### BACKGROUND

### 1. Technical Field

The present disclosure relates to an ink jet ink set and an ink jet recording method.

### 2. Related Art

Ink jet recording methods can record high-definition images with a relatively simple apparatus and have been rapidly developed in various fields. In the development, various studies have been made on the friction fastness and other properties of the formed images. For example, JP-A-2023-088510 discloses a technique of applying a coating liquid containing no coloring material onto a pigment-containing water-based ink in order to improve the friction fastness.

However, in the technique disclosed in JP-A-2023-088510, it is difficult to obtain a black image having a high OD (optical density) value because the lightness of the image tends to be increased by the coating liquid. In view of this, a technique capable of forming an image having both the friction fastness and the black color development property is required.

### SUMMARY

According to an aspect of the present disclosure, an ink set includes a first ink jet ink and a second ink jet ink. The first ink jet ink contains a first pigment containing a black pigment, a first binder resin containing an anionic urethane resin particle, an organic solvent, and water. The first pigment is contained in an amount of 3% by mass or more based on a total amount of the first ink jet ink. The anionic urethane resin particle is contained in an amount of 5% by mass or more based on the total amount of the first ink jet ink. The anionic urethane resin particle is an only resin particle contained in a largest amount in the first binder resin. The second ink jet ink contains a second pigment containing at least one selected from the group consisting of a black pigment and a blue pigment, a second binder resin containing an anionic acrylic resin particle, an organic solvent, and water. The second pigment is contained in an amount of 3% by mass or more based on a total amount of the second ink jet ink. The anionic acrylic resin particle is contained in an amount of 3% by mass or more based on the total amount of the second ink jet ink. The anionic acrylic resin particle is an only resin particle contained in a largest amount in the second binder resin.

According to an aspect of the present disclosure, an ink jet recording method includes using the above-described ink jet ink set, attaching the first ink jet ink to a recording medium by ejecting the first ink jet ink using an ink jet method, and attaching the second ink jet ink to the recording medium by ejecting the second ink jet ink using an ink jet method. The attaching the first ink jet ink and the attaching the second ink jet ink are performed on a same region of the recording medium.

### BRIEF DESCRIPTION OF THE DRAWINGS

FIG. 1 is a view illustrating an example of a serial ink jet recording apparatus.

FIG. 2 is a table showing results of Examples.

FIG. 3 is a table showing results of Examples.

### DESCRIPTION OF EMBODIMENTS

Hereinafter, an embodiment of the present disclosure (hereinafter, referred to as “the present embodiment”) will be described in detail with reference to the drawings as necessary, but the present disclosure is not limited thereto, and various modifications can be made without departing from the gist of the present disclosure. In the drawings, the same elements are denoted by the same reference numerals, and the repetitive description will be omitted. In addition, positional relationships such as up, down, left, and right are based on the positional relationships shown in the drawings unless otherwise specified. Furthermore, the dimensional ratios in the drawings are not limited to the ratios shown in the drawings.

In the present embodiment, an “ink jet ink” is also simply referred to as “ink”. For example, an “ink jet ink set” is also referred to as an “ink set”, a “first ink jet ink” is also referred to as a “first ink”, and a “second ink jet ink” is also referred to as a “second ink”.

### 1. Ink Jet Ink Set

The ink set of the present embodiment includes a first ink and a second ink. The first ink contains a first pigment containing a black pigment, a first binder resin containing an anionic urethane resin particle, an organic solvent, and water. The amount of the first pigment is 3% by mass or more based on the total amount of the first ink. The amount of the anionic urethane resin particle is 5% by mass or more based on the total amount of the first ink. The anionic urethane resin particle is the only resin particle contained in the largest amount in the first binder resin. The second ink contains a second pigment containing at least one selected from the group consisting of a black pigment and a blue pigment, a second binder resin containing an anionic acrylic resin particle, an organic solvent, and water. The second pigment is contained in an amount of 3% by mass or more based on the total amount of the second ink. The amount of the anionic acrylic resin particle is 3% by mass or more based on the total amount of the second ink. The anionic acrylic resin particle is the only resin particle that is contained in the largest amount in the second binder resin.

Since the urethane resin is relatively likely to aggregate, it tends to improve the friction fastness of the obtained coating film. However, since the urethane resin is likely to shrink, it tends to lower the smoothness of the obtained coating film. As a result, light passing through the coating film is likely to be scattered, which causes a decrease in black color development property. For these reasons, it is difficult to achieve both the friction fastness and the black color development property by using the urethane resin alone.

In contrast, since the acrylic resin has high transparency and good film-forming properties, it tends to improve the smoothness of the obtained coating film. Thus, a coating film that hardly scatters light can be obtained by using the acrylic resin. In addition, the acrylic resin is relatively unlikely to aggregate and tends to promote the wet-spreading of the ink and improve the filling property of the ink in the recording medium. As described above, since a coating film having low scattering properties and high filling properties can be formed by using the acrylic resin, an image having a higher black color development property than that obtained with the urethane resin tends to be obtained. However, since the acrylic resin is less likely to aggregate, the resulting coating film tends to have a lower friction fastness than that obtained with the urethane resin. For these reasons, when the acrylic resin is used alone, it is difficult to achieve both the friction fastness and black color development property.

In addition, even when the urethane resin and the acrylic resin are used in combination in one ink, it is difficult to achieve both the friction fastness and black color development property at a high level. It is presumed that this is because, when the urethane resin and the acrylic resin are contained in substantially the same amount in one ink, the two kinds of resins are present in a uniformly mixed state in the coating film of the ink, so that neither a coating film having high friction fastness originating from the urethane resin nor a coating film having high color developability originating from the acrylic resin can be formed, and the performances of the two cancel each other out. In addition, when one ink contains both a urethane resin and an acrylic resin, there is also a problem of deterioration of ink storage stability.

However, the present embodiment uses the first ink, which contains the anionic urethane resin particle as the binder resin in the largest amount, and the second ink, which contains the anionic acrylic resin particle as the binder resin in the largest amount, separately as a set. With this configuration, the present embodiment can form an image having both the friction fastness and black color development property. The reason for this is presumed as follows. When the coating film is formed by the first ink, which is rich in the urethane resin, and the second ink, which is rich in the acrylic resin, the urethane resin and the acrylic resin are present in the coating film with a certain degree of independence from one another. In this state, because the urethane resin and the acrylic resin are not excessively mixed with each other, the performances of the urethane resin and the acrylic resin are less likely to cancel each other out, allowing both the friction fastness and black color development property to be achieved. This mechanism in which the effect occurs is speculative, and the mechanism of the present embodiment is not limited to this.

In addition, the ink set of the present embodiment is preferably a set of the first ink, which is a black ink, and the second ink, which is a blue ink or a black ink. The use of the first ink and the second ink in combination tends to further improve the black color development property.

The ink set of the present embodiment is not particularly limited, but is preferably for textile printing. Since fabrics tend to have high ink permeability, it is difficult to achieve both the friction fastness and black color development property. However, with the ink set of the present embodiment, it is possible to achieve both the friction fastness and black color development property even in textile printing in which printing is performed on fabrics.

### 1.1. First Ink Jet Ink

The first ink contains a first pigment containing a black pigment, a first binder resin containing an anionic urethane resin particle, an organic solvent, and water. The first ink is preferably a black ink from the viewpoint of improving the black color development property of the image. In the present embodiment, the “black ink” refers to an ink in which L* is 50 or less, a* is 10 or less, and b* is 10 or less in the Lab color space of a printed image produced by a predetermined printing method. The predetermined printing method is as follows. An ink jet printer is used to eject ink onto a fabric. The print resolution is 1440×720 dpi, the ink ejection amount is 22 ng/dot, and the ink application amount is 22.8 mg/inch². The fabric on which the image was recorded was dried at 160° C. for 3 minutes to form a printed image.

### 1.1.1. First Pigment

The first pigment contains a black pigment. The first pigment may contain a pigment other than the black pigment. However, since the first ink is preferably a black ink, the first pigment preferably does not contain a pigment other than the black pigment. When the first pigment contains a pigment other than the black pigment, it is preferable that the first pigment contain the black pigment as the pigment solely contained in the largest amount in the first pigment.

Examples of the black pigment include carbon blacks (C.I. Pigment Black 7) such as furnace black, lamp black, acetylene black, and channel black, metals such as copper oxide and iron oxide (C. I. Pigment Black 11), and organic pigments such as aniline black (C. I. Pigment Black 1). Among these, the black pigment is preferably carbon black. Carbon black has a relatively low specific gravity and is unlikely to precipitate in the ink.

The black pigment may be self-dispersible or polymer-dispersible, but is preferably self-dispersible. The self-dispersible black pigment is more likely to improve the black color development property of an image than a polymer-dispersible black pigment. In the present embodiment, the “self-dispersible” means that the pigment is dispersed by itself without the presence of a dispersant or the like. In contrast, the “polymer-dispersible” means that the pigment is dispersed by using a polymer dispersant. The polymer dispersant that disperses the pigment does not correspond to the “binder resin” in the present embodiment. The black pigment is particularly preferably a self-dispersible carbon black.

The first pigment is contained in an amount of 3% by mass or more, preferably 4% by mass or more, and 5% by mass or more, based on the total amount of the first ink. This tends to further improve the black color development property of the image. The first pigment is contained in an amount of preferably 10% by mass or less, and 8% by mass or less, based on the total amount of the first ink.

### 1.1.2. First Binder Resin

The first binder resin contains the anionic urethane resin particle as the only resin particle contained in the largest amount in the first binder resin. The “only resin particle contained in the largest amount in the first binder resin” can also be referred to as “the resin particle solely contained in the largest amount in the first binder resin”. That is, the first binder resin may contain a resin particle other than the anionic urethane resin particle, but the amount of the resin particle is smaller than the amount of the anionic urethane resin particle.

If the ink contains 50 parts by mass of the anionic urethane resin particle and 50 parts by mass of the resin particle other than the anionic urethane resin particle based on 100 parts by mass of the binder resin, two resin particles are contained in the largest amount, and “the only resin particle contained in the largest amount” is not present. Thus, it is determined that the above requirement is not satisfied.

The urethane resin constituting the urethane resin particle is not particularly limited as long as it is a resin having a urethane bond in the molecule. Examples of the urethane resin include a polyether-type urethane resin having an ether bond in the main chain, a polyester-type urethane resin having an ester bond in the main chain, and a polycarbonate-type urethane resin having a carbonate bond in the main chain.

When the urethane resin particle is anionic, the dispersion stability tends to be further improved. The anionic urethane resin particle has, for example, a carboxy group, a sulfo group, or a hydroxy group.

The amount of the anionic urethane resin particle is 5% by mass or more based on the total amount of the first ink. This tends to further improve the friction fastness of the image. In addition, the anionic urethane resin particle is contained in an amount of preferably 12% by mass or less, 10% by mass or less, and 8% by mass or less, based on the total amount of the second ink. This tends to further improve the black color development property of the image.

The first binder resin is contained in an amount of preferably 12% by mass or less, 10% by mass or less, and 8% by mass or less, based on the total amount of the first ink. This tends to further improve the ejection stability and black color development property of the image. The first binder resin is contained in an amount of 5% by mass or more based on the total amount of the first ink.

The sum of the amounts of the first pigment and the first binder resin is preferably 15% by mass or less, 13% by mass or less, 11% by mass or less, and 10% by mass or less, based on the total amount of the first ink. This tends to further improve the ejection stability. The sum of the amounts of the first pigment and the first binder resin is preferably 6% by mass or more, 7% by mass or more, and 8% by mass or more, based on the total amount of the first ink. This tends to further improve the black color development property of the image and the friction fastness of the image.

### 1.1.3. Organic Solvent

The first ink contains an organic solvent. Examples of the organic solvent include glycerin, glycols such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, and 1,6-hexanediol, glycol monoethers such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, and triethylene glycol monomethyl ether, nitrogen-containing solvents such as 2-pyrrolidone, N-methyl-2-pyrrolidone, and N-ethyl-2-pyrrolidone, and alcohols such as methanol, ethanol, n-propyl alcohol, iso-propyl alcohol, n-butanol, 2-butanol, tert-butanol, iso-butanol, n-pentanol, 2-pentanol, 3-pentanol, and tert-pentanol.

Among these, the organic solvent is preferably glycerin or glycols, and more preferably glycerin or triethylene glycol. The organic solvent may be used alone or in combination of two or more kinds thereof.

The organic solvent is contained in an amount of preferably 5.0 to 30% by mass, 10 to 25% by mass, and 15 to 20% by mass, based on the total amount of the first ink. When the amount of the organic solvent is within the above range, the storage stability and the mechanical stability tend to be further improved.

### 1.1.4. Water

The first ink contains water. The water is contained in an amount of preferably 55 to 85% by mass, 60 to 80% by mass, and 65 to 75% by mass, based on the total amount of the first ink.

### 1.1.5. pH Adjuster

The first ink may contain a pH adjuster. The pH adjuster is not particularly limited, and examples thereof include inorganic acids (e.g., sulfuric acid, hydrochloric acid, nitric acid, and the like), inorganic bases (e.g., lithium hydroxide, sodium hydroxide, potassium hydroxide, ammonia, and the like), organic bases (triethanolamine, diethanolamine, monoethanolamine, and triisopropanolamine), and organic acids (e.g., adipic acid, citric acid, succinic acid, and the like). When the pH adjuster is contained, the dispersion stability tends to be further improved. The pH adjuster may be used alone or in combination of two or more kinds thereof.

The pH adjuster is contained in an amount of preferably 0.01 to 1.5% by mass, 0.05 to 1.0% by mass, and 0.1 to 0.75% by mass, based on the total amount of the first ink. When the amount of the pH adjuster is within the above range, the dispersion stability tends to be further improved.

### 1.1.6. Surfactant

The first ink may contain a surfactant. The surfactant is not particularly limited, and examples thereof include an acetylene glycol-based surfactant, a fluorine-based surfactant, and a silicone-based surfactant. The surfactants may be used alone or in combination of two or more kinds thereof.

The acetylene glycol-based surfactant is not particularly limited, and is, for example, preferably at least one selected from the group consisting of 2,4,7,9-tetramethyl-5-decyne-4,7-diol, an alkylene oxide adduct of 2,4,7,9-tetramethyl-5-decyne-4,7-diol, 2,4-dimethyl-5-decyne-4-ol and an alkylene oxide adduct of 2,4-dimethyl-5-decyne-4-ol. Commercially available products of the acetylene glycol-based surfactants are not particularly limited, and examples thereof include OLFINE E1010 and D-10PG (manufactured by Nissin Chemical Industry Co., Ltd).

The fluorine-based surfactant is not particularly limited, and examples thereof include perfluoroalkyl sulfonates, perfluoroalkyl carboxylates, perfluoroalkyl phosphate esters, perfluoroalkyl ethylene oxide adducts, perfluoroalkyl betaines, and perfluoroalkylamine oxide compounds.

Examples of the silicone-based surfactant include a polysiloxane-based compound and polyether-modified organosiloxane.

The HLB (Hydrophile-Lipophile Balance) value of the surfactant is preferably 10 or more, more preferably 10 to 18, and still more preferably 12 to 16. When the HLB value of the surfactant is within the above range, the storage stability and mechanical stability of the ink tends to be further improved. The HLB value in this specification is defined by the Griffin's method.

Among these, an acetylene glycol-based surfactant is preferable, and an acetylene glycol-based surfactant having the HLB value of 10 or more is more preferable. The use of such a surfactant further improves the storage stability and mechanical stability of the ink and suppresses the permeability of the ink into a recording medium, and thus the black color development property of the image tends to be further improved.

The surfactant is contained in an amount of preferably 0.3 to 2.5% by mass, and 0.5 to 2.0% by mass, based on the total amount of the first ink. When the amount of the surfactant is within the above range, the black color development property of the image and the storage stability and mechanical stability of the ink tend to be further improved.

### 1.1.7. Other Components

The first ink may contain components other than those described above, such as a chelating agent, a softening agent, a solubilizing agent, a viscosity modifier, an ultraviolet absorber, an antioxidant, and a corrosion inhibitor.

1.1.8. pH

The pH of the first ink at 25° C. is preferably 8 to 11, 8.2 to 10, and 8.4 to 9.5. The urethane resin particle contained in the first ink may be anionic, and the pigment may also be anionic. When the pH is 8 or more, these anionic components are less likely to aggregate, and thus the ejection stability tends to be further improved. When the pH is 11 or less, the anionic components are less likely to be redispersed after the coating film is formed, and thus the friction fastness of the image tends to be further improved.

### 1.2. Second Ink Jet Ink

The second ink contains a second pigment containing at least one selected from the group consisting of a black pigment and a blue pigment, a second binder resin containing an anionic acrylic resin particle, an organic solvent, and water. The second ink is preferably a black ink or a blue ink from the viewpoint of improving the black color development property of the image. The “blue ink” refers to an ink that exhibits a maximum absorption wavelength in a range of 550 to 650 nm in the visible light range of 350 to 800 nm, when diluted with water and subjected to spectrophotometric measurement, and that does not fall under the definition of the “black ink”.

### 1.2.1. Second Pigment

The second pigment contains at least one selected from the group consisting of a black pigment and a blue pigment. The second pigment may contain a pigment other than the black pigment or the blue pigment. However, since the second ink is preferably a black ink or a blue ink, the second pigment preferably does not contain a pigment other than the black pigment or the blue pigment. When the second pigment contains a pigment other than the black pigment or the blue pigment, it is preferable that the second pigment contain one selected from the group consisting of a black pigment and a blue pigment as the pigment solely contained in the largest amount in the second pigment.

The black pigment that can be contained in the second pigment is the same as the black pigment contained in the first pigment. That is, the black pigment is preferably carbon black. In addition, the black pigment is preferably self-dispersible, and particularly preferably a self-dispersible carbon black.

Examples of the blue pigment include C.I. Pigment Blue 1, 2, 3, 15, 15:1, 15:2, 15:3, 15:34, 15:4, 16, 18, 22, 25, 60, 65, and 66. Among these, the blue pigment preferably contains C.I. Pigment Blue 15:3.

The blue pigment may be self-dispersible or polymer-dispersible, but is preferably polymer-dispersible. The polymer-dispersible blue pigment is more likely to improve the friction fastness of an image than the self-dispersible blue pigment.

The second pigment is contained in an amount of 3% by mass or more, preferably 3.5% by mass or more, and 4% by mass or more, based on the total amount of the second ink. This tends to further improve the black color development property of the image. The second pigment is contained in an amount of preferably 10% by mass or less, and 8% by mass or less, based on the total amount of the second ink.

### 1.2.2. Second Binder Resin

The second binder resin contains the anionic acrylic resin particle as the only resin particle contained in the largest amount in the second binder resin. The “only resin particle contained in the largest amount in the second binder resin” is also referred to as “the resin particle solely contained in the largest amount in the second binder resin”. That is, the second binder resin may contain a resin particle other than the anionic acrylic resin particle, but the amount of the resin particle is smaller than the amount of the anionic acrylic resin particle.

If the ink contains 50 parts by mass of the anionic acrylic resin particle and 50 parts by mass of the resin particle other than the anionic acrylic resin particle based on 100 parts by mass of the binder resin, two resin particles are contained in the largest amount, and “the only resin particle contained in the largest amount” is not present. Thus, it is determined that the above requirement is not satisfied.

Examples of the acrylic resin constituting the acrylic resin particle include a resin obtained by polymerizing a (meth)acrylic monomer, such as (meth)acrylic acid or a (meth)acrylic acid ester, and a resin obtained by copolymerizing a (meth)acrylic monomer and another monomer.

When the acrylic resin particle is anionic, the dispersion stability tends to be further improved. The anionic acrylic resin particle has, for example, a carboxy group, a sulfo group, or a hydroxy group.

The anionic acrylic resin particle is contained in an amount of 3% by mass or more, preferably 4% by mass or more, and 5% by mass or more, based on the total amount of the second ink. This tends to further improve the friction fastness of the image. In addition, the anionic acrylic resin particle is contained in an amount of preferably 12% by mass or less, 10% by mass or less, and 8% by mass or less, based on the total amount of the second ink. This tends to further improve the black color development property of the image.

The second binder resin is contained in an amount of preferably 12% by mass or less, 10% by mass or less, and 8% by mass or less, based on the total amount of the second ink. This tends to further improve the ejection stability and black color development property of the image. In addition, the second binder resin is contained in an amount of preferably 3% by mass or more, 4% by mass or more, and 5% by mass or more, based on the total amount of the second ink. This tends to further improve the friction fastness of the image.

The sum of the amounts of the second pigment and the second binder resin is preferably 17% by mass or less, 15% by mass or less, and 13% by mass or less, based on the total amount of the second ink. This tends to further improve the ejection stability. In addition, the sum of the amounts of the second pigment and the second binder resin is preferably 6% by mass or more, 8% by mass or more, and 10% by mass or more, based on the total amount of the second ink. This tends to further improve the friction fastness of the image.

### 1.2.3. Organic Solvent

The second ink contains an organic solvent. Examples of the organic solvent contained in the second ink are the same as those of the organic solvent contained in the first ink. The organic solvent contained in the second ink may be the same as or different from the organic solvent contained in the first ink.

The organic solvent is contained in an amount of preferably 5.0 to 30% by mass, 10 to 25% by mass, and 15 to 20% by mass, based on the total amount of the second ink. When the amount of the organic solvent is within the above range, the storage stability and the mechanical stability tend to be further improved.

### 1.2.4. Water

The second ink contains water. The water is contained in an amount of preferably 55 to 85% by mass, 60 to 80% by mass, and 65 to 75% by mass, based on the total amount of the second ink.

### 1.2.5. pH Adjuster

The second ink may contain a pH adjuster. Examples of the pH adjuster that can be contained in the second ink are the same as those of the pH adjuster contained in the first ink. The pH adjuster contained in the second ink may be the same as or different from the pH adjuster contained in the first ink.

The pH adjuster is contained in an amount of preferably 0.01 to 1.5% by mass, 0.05 to 1.0% by mass, and 0.1 to 0.75% by mass, based on the total amount of the second ink. When the amount of the pH adjuster is within the above range, the dispersion stability tends to be further improved.

### 1.2.6. Surfactant

The second ink may contain a surfactant. Examples of the surfactant that can be contained in the second ink are the same as those of the surfactant contained in the first ink. The surfactant contained in the second ink may be the same as or different from the surfactant contained in the first ink.

The surfactant is contained in an amount of preferably 0.3 to 2.5% by mass, and 0.5 to 2.0% by mass, based on the total amount of the second ink. When the amount of the surfactant is within the above range, the black color development property of the image and the storage stability and mechanical stability of the ink tend to be further improved.

### 1.2.7. Other Components

The second ink may contain components other than those described above, such as a chelating agent, a softening agent, a solubilizing agent, a viscosity modifier, an ultraviolet absorber, an antioxidant, and a corrosion inhibitor.

1.2.8. pH

The pH of the second ink at 25° C. is preferably 8 to 11, 8.1 to 10, or 8.2 to 9. The acrylic resin particle contained in the second ink may be anionic, and the pigment may also be anionic. When the pH is 8 or more, these anionic components are less likely to aggregate, and thus the ejection stability tends to be further improved. When the pH is 11 or less, the anionic components are less likely to be redispersed after the coating film is formed, and thus the friction fastness of the image tends to be further improved.

### 1.3. Method for Producing Ink

The first ink and the second ink can be produced by, for example, mixing the components in any order and performing filtration or the like as necessary to remove impurities, foreign substances, and the like. As a method of mixing the components, a method of sequentially adding each component into a vessel equipped with a stirring device such as a mechanical stirrer or a magnetic stirrer, followed by stirring and mixing, is used. Examples of the filtration method include centrifugal filtration and filter filtration.

### 2. Ink Jet Recording Method

The ink jet recording method of the embodiment uses the ink set described above and includes a first ink attaching step and a second ink attaching step performed on the same region of the recording medium. The first ink attaching step includes attaching the first ink to the recording medium by ejecting the first ink using an ink jet method. The second ink attaching step includes attaching the second ink to the recording medium by ejecting the second ink using an ink jet method. When the first ink attaching step and the second ink attaching step are performed on the same region of the recording medium, the urethane resin and the acrylic resin are present in the coating film with a certain degree of independence from one another. In this state, because the urethane resin and the acrylic resin are not excessively mixed with each other, the performances of the urethane resin and the acrylic resin are less likely to cancel each other out, allowing both the friction fastness and black color development property to be achieved.

The recording medium is not particularly limited, but is preferably a fabric. Since fabrics tend to have high ink permeability, it is difficult to achieve both the friction fastness and black color development property. However, with the ink set of the present embodiment, it is possible to achieve both the friction fastness and black color development property even when the recording medium is a fabric. The fibers constituting the fabric are not particularly limited, and examples thereof include natural fibers and synthetic fibers such as silk, cotton, wool, nylon, polyester, and rayon.

The ink attachment amount in the first ink attaching step is preferably 8 mg/inch² or more, 10 mg/inch² or more, 12 mg/inch² or more, 13 mg/inch² or more, 15 mg/inch² or more, 17 mg/inch² or more, and 19 mg/inch² or more. The ink attachment amount in the first ink attaching step is preferably 40 mg/inch² or less, 35 mg/inch² or less, 30 mg/inch² or less, and 25 mg/inch² or less.

The ink attachment amount in the second ink attaching step is preferably 10 mg/inch² or more, 13 mg/inch² or more, 15 mg/inch² or more, 17 mg/inch² or more, or 19 mg/inch² or more. The ink attachment amount in the second ink attaching step is preferably 30 mg/inch² or less, 25 mg/inch² or less, 20 mg/inch² or less, or 15 mg/inch² or less.

When the ink attachment amount in the first ink attaching step and the ink attachment amount in the second ink attaching step are in the above-described ranges, both the friction fastness and black color development property of the image tend to be improved.

The sum of the ink attachment amount in the first ink attaching step and the ink attachment amount in the second ink attaching step is preferably 20 to 50 mg/inch², 26 to 40 mg/inch², and 30 to 40 mg/inch². This makes it easy to achieve both the friction fastness and black color development property of an image at a high level.

The ratio of the ink attachment amount in the first ink attaching step to the ink attachment amount in the second ink attaching step is preferably 0.3 to 2.5, and more preferably 0.5 to 2.0.

When the second pigment contains a blue pigment, or when the second ink is a blue ink, the ink attachment amount in the first ink attaching step is preferably larger than the ink attachment amount in the second ink attaching step. This tends to further improve the black color development property of the image.

Each of the first ink attaching step and the second ink attaching step may be performed on the same region of the recording medium multiple times or may be performed only one time. Furthermore, the first ink attaching step and the second ink attaching step may be performed simultaneously or in any order, such as alternately.

In the ink jet recording method, an ink other than the first ink and the second ink, or a treatment liquid may be used as long as the effects of the present disclosure are not impaired. Examples of the treatment liquid include a pretreatment liquid and a coating liquid.

### 3. Ink jet Recording Apparatus

The ink jet recording apparatus used in the ink jet recording method is not particularly limited and may be, for example, a serial ink jet recording apparatus or a line ink jet recording apparatus. The serial ink jet recording apparatus refers to an ink jet recording apparatus in which a head unit is mounted on a carriage, which moves in a main scanning direction (a lateral direction, a width direction of a recording medium), and liquid droplets are ejected from the nozzles onto the recording medium as the carriage moves. The line ink jet recording apparatus refers to an ink jet recording apparatus in which a head is fixed. A recording medium is moved in a sub-scanning direction (a longitudinal direction of the recording medium, a transport direction), and liquid droplets are ejected from the nozzles of the head in conjunction with the movement.

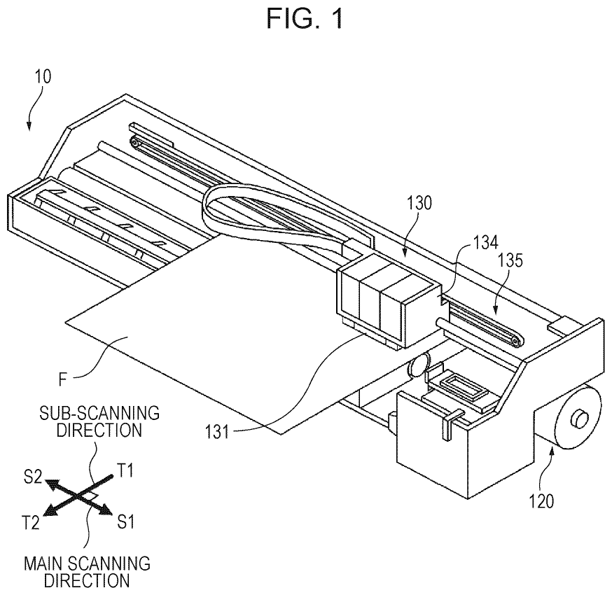

FIG. 1 is a perspective view illustrating an example of a serial ink jet recording apparatus. The ink jet recording apparatus 10 illustrated in FIG. 1 includes a transport unit 120 and a recording unit 130. The transport unit 120 includes a feed roller that transports the recording medium F in the sub-scanning direction T2, and the transport unit 120 transports the recording medium F to the recording unit 130 and discharges the recording medium F after recording. The recording unit 130 includes a carriage 134 and a carriage moving mechanism 135 that moves the carriage 134 in the main scanning directions S1 and S2. The ink jet head 131 is mounted on the carriage 134. The ink jet head 131 has nozzles for ejecting ink onto the recording medium F. With the movement of the carriage 134, the ink jet head 131 is moved in the main scanning directions S1 and S2 (main scanning, pass). The ink jet head 131 ejects ink onto the recording medium F while moving in the main scanning directions S1 and S2. The serial ink jet recording apparatus 10 forms an image by using two or more passes (multi-pass). Between passes, the recording medium F is transported (sub-scanning). In the serial ink jet recording apparatus 10, for example, the main scanning and sub-scanning are alternately performed.

### EXAMPLES

Hereinafter, the present disclosure will be described in more detail with reference to Examples and Comparative Examples. The present disclosure is not limited by Examples below in any way.

### 1. Preparation of Pigment Dispersion Liquid

### 1.1. Preparation of Self-Dispersible Black Pigment Dispersion Liquid

To 3750 g of ion exchange water, 500 g of a carbon black raw material (primary particle diameter=18 nm, BET specific surface area=180 m²/g, DBP absorption amount=186 mL/100 g) prepared by the furnace method was added, and the temperature was raised to 45° C. while the mixture was being stirred with a dissolver. Then, while pulverizing the mixture with a sand mill using zirconia beads having a diameter of 0.8 mm, 30000 g of an aqueous solution of sodium hypochlorite (effective chlorine concentration=12%) was added dropwise over 3.5 hours at 45° C. Subsequently, the pulverization with the sand mill was continued for further 30 minutes to obtain a treatment liquid containing a self-dispersible carbon black. This treatment liquid was filtered through a 400-mesh wire net to separate the zirconia beads and the unreacted carbon black from the treatment liquid. To the treatment liquid obtained through the separation, a 5% potassium hydroxide aqueous solution was added to adjust the pH to 7.5. Desalination and purification were then carried out using an ultrafiltration membrane until the electrical conductivity of the liquid reached 1.5 mS/cm. Desalination and purification were then further carried out using an electrodialyzer until the electrical conductivity of the liquid reached 1.0 mS/cm. The liquid was concentrated until the concentration of the self-dispersible carbon black reached 17% by mass. The concentrate was subjected to centrifugal separation with a centrifugal separator to remove coarse particles, followed by filtration through a 0.6 μm filter. Ion-exchanged water was added to the obtained filtrate to dilute the filtrate until the concentration of the self-dispersible carbon black reached 15% by mass, followed by dispersion, to obtain a self-dispersible black pigment dispersion liquid.

### 1.2. Preparation of Polymer-Dispersible Black Pigment Dispersion Liquid

To 15 parts by mass of carbon black, 10 parts by mass of ammonium salt (weight average molecular weight: 10000) of a styrene-acrylic acid copolymer was added as a polymer component serving as a dispersant, together with 55 parts by mass of ion exchange water, followed by sufficient mixing. Then, this mixture was dispersed for 2 hours together with glass beads (diameter: 1.7 mm, 1.5 times the amount of the mixture) in a sand mill (manufactured by Yasukawa Seisakusho Co., Ltd.). After the dispersion, the glass beads were removed to obtain a polymer-dispersible black pigment dispersion liquid containing the polymer-dispersible carbon black.

### 1.3. Preparation of Polymer-Dispersible Cyan Pigment Dispersion Liquid

A polymer-dispersible cyan pigment dispersion liquid was obtained in the same manner as the polymer-dispersible black pigment dispersion liquid, except that C.I. Pigment Blue 15:3 was used instead of the carbon black.

### 1.4. Preparation of Polymer-Dispersible Yellow Pigment Dispersion Liquid

A polymer-dispersible yellow-pigment dispersion liquid was obtained in the same manner as the polymer-dispersible black pigment dispersion liquid, except that C.I. Pigment Yellow 180 was used instead of the carbon black.

### 1.5. Preparation of Polymer-Dispersible Magenta Pigment Dispersion Liquid

A polymer-dispersible magenta pigment dispersion liquid was obtained in the same manner as the polymer-dispersible black pigment dispersion liquid, except that C.I. Pigment Red 122 was used instead of the carbon black.

### 2. Preparation of Binder Resin Dispersion Liquid

### 2.1. Preparation of Urethane-Based Binder Resin Dispersion Liquid

Into a four-neck flask equipped with a stirrer, a cooling tube, a nitrogen introduction tube, and a thermometer, 322.2 g of polytetramethylene ether glycol having a number average molecular weight of 1000, 19.7 g of 2,2-dimethylolbutanoic acid, 16.9 g of 1,4-butanediol, 137.9 g of hexamethylene diisocyanate, and 344.0 g of methyl ethyl ketone were put, and the mixture was reacted at 80° C. in a nitrogen gas atmosphere for 6 hours. Then, the reactant was cooled to 60° C., and 12.5 g of triethylamine was added to the reactant, followed by mixing for 30 minutes at this temperature. The obtained prepolymer was mixed with 1146.7 g of deionized water and stirred for 2 hours. Then, the methyl ethyl ketone was removed at 40° C. under reduced pressure. Thus, a urethane-based binder resin dispersion liquid containing an anionic urethane resin particle having a carboxy group as an acidic group was obtained. The solids concentration in the obtained dispersion liquid was 30% by mass.

### 2.2. Preparation of Acrylic-Based Binder Resin Dispersion Liquid

Into a reaction vessel equipped with a stirrer, a reflux condenser, a dropping device, and a thermometer, 2600 g of ion-exchanged water and 0.5 g of sodium lauryl sulfate were put, and the temperature was raised to 70° C. while the mixture was stirred and purged with nitrogen. While maintaining the internal temperature at 70° C., 4 g of potassium persulfate as a polymerization initiator was added and dissolved, and then an emulsion prepared in advance by adding, under stirring, 2 g of acrylamide, 180 g of methyl methacrylate, 25 g of butyl acrylate, and 2 g of methacrylic acid to 300 g of ion-exchanged water and 0.5 g of sodium lauryl sulfate was continuously added dropwise into the reaction solution over 3 hours. After the end of the dropwise addition, the mixture was aged for 1 hour. After the end of the aging, an emulsion prepared in advance by adding, under stirring, 30 g of acrylamide, 1200 g of styrene, 200 g of 2-ethylhexyl methacrylate, and 30 g of methacrylic acid to 500 g of ion-exchanged water and 1.5 g of sodium lauryl sulfate was continuously added dropwise into the reaction solution over 4 hours. After the end of the dropwise addition, the mixture was aged for 3 hours. After the obtained aqueous emulsion was cooled to room temperature, ion-exchanged water and aqueous sodium hydroxide were added to adjust the solids concentration to 30% by mass and pH to 8. Thus, an acrylic-based binder resin dispersion liquid containing an anionic acrylic resin particle having a carboxy group as an acidic group was obtained.

### 3. Ink Preparation

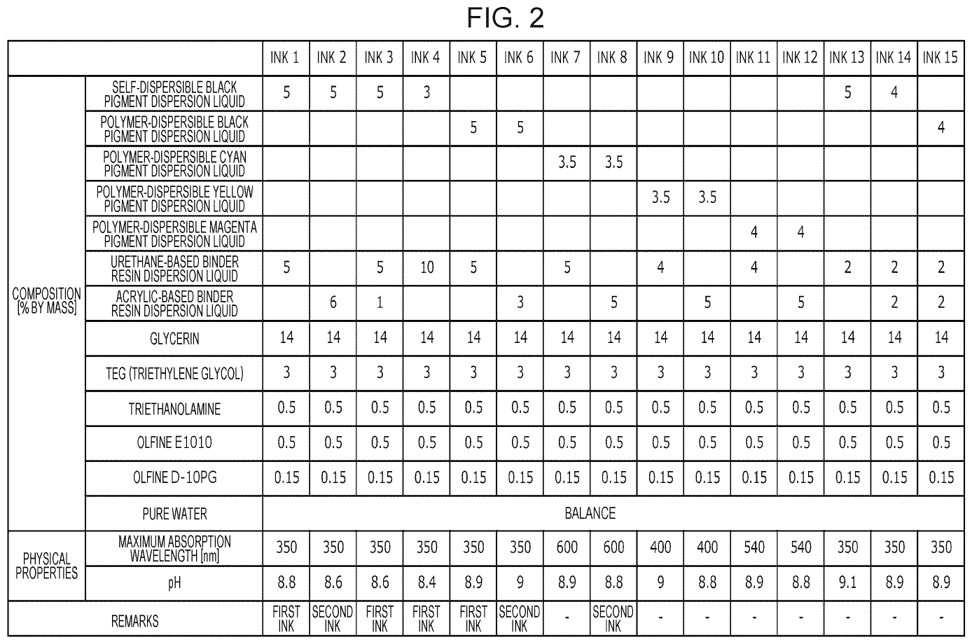

The materials were mixed according to the compositions shown in the table of FIG. 2 and sufficiently stirred to obtain Inks 1 to 15. The compositions of the pigment dispersion liquids in the table of FIG. 2 are expressed in terms of pigment equivalents. The compositions of the binder resin dispersion liquids in the table of FIG. 2 are expressed in terms of binder resin equivalents. The unit of the composition in the table of FIG. 2 is % by mass, and the total composition is 100.0% by mass. OLFINE E1010 and OLFINE D-10PG are both acetylene glycol-based surfactants manufactured by Nissin Chemical Industry Co., Ltd.

### 4. Measurement of Maximum Absorption Wavelength of Ink

Each ink was diluted with pure water at a dilution rate at which the maximum Abs. at 350 to 800 nm was 1 by using a spectrophotometer (“U-39000H” manufactured by Hitachi High-Tech Science Corporation), and the maximum absorption wavelength was measured. The measurement results are shown in the table of FIG. 2.

### 5. pH Measurement of Ink

The pH of each ink at 25° C. was measured using a benchtop pH meter (model: F-72, manufacturer: HORIBA, Ltd). The measurement results are shown in the table of FIG. 2.

### 6. Ink Jet Recording (Textile Printing)

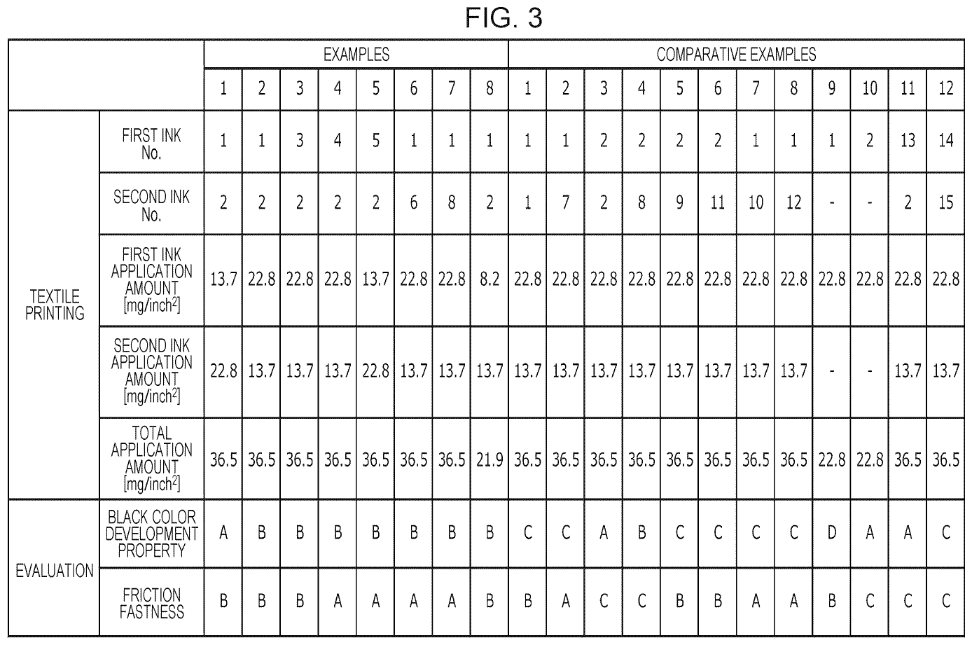

Cartridges of an ink jet printer (manufactured by Seiko Epson Corporation, product name: “PX-G930”) were filled with the respective inks prepared above. Using this printer, a solid image was recorded on pretreated cotton (manufactured by Fortex Co., Ltd., product name: COT-PT, cotton: 100%, basis weight: 130 g/m²) by ejecting the prepared ink from the head in the same pass. The print resolution was 1440×720 dpi. The ink ejection amount was 22 ng/dot. The combination of inks and the application amount of each ink in Examples 1 to 8 and Comparative Examples 1 to 12 were as shown in the table of FIG. 3. The fabric on which the image was recorded was dried at 160° C. for 3 minutes to obtain a printed fabric.

### 7. Measurement of L*, a*, and b*

The values of L*, a*, and b* in the Lab color space of the obtained printed image were measured. As a result, in the inks of Examples that contain the black pigment dispersion liquid, L* was 50 or less, a* was 10 or less, and b* was 10 or less. In contrast, in the inks of Examples that did not contain the black pigment dispersion liquid, at least one of L*, a*, and b* was not in the above-described range.

### 8. Evaluation

### 8.1. Black Color Development Property (Optical Density of Black)

For each of the printed fabrics produced above, the black optical density (OD, Status E) of the printed image was measured, and the evaluation was further performed according to the following criteria. The black color development property was evaluated in this way.
A: OD of black of the printed image is 1.60 or more.
B: OD of black of the printed image is 1.56 or more and less than 1.60.
C: OD of black of the printed image is 1.52 or more and less than 1.56.
D: OD of black of the printed image is less than 1.52.

### 8.2. Friction Fastness (Wet Friction Fastness)

Using a crockmeter (FI-306, manufactured by Tester Sangyo Co., Ltd.), shirting (white cotton cloth) wetted with pure water and in a wet state of about 100% was rubbed on the image of the printed fabric prepared above 10 times with a load of 9N. Then, for the region contaminated with the ink of the rubbed shirting, the optical density (OD, Status E) of black of the printed image was measured using a colorimeter (FD-7, manufactured by Konica Minolta Inc.), and the evaluation was further performed according to the following criteria. The friction fastness was evaluated in this way.
A: OD of black in the contaminated region is 0.5 or less.
B: OD of black in the contaminated region is more than 0.5 and 0.6 or less.
C: OD of black in the contaminated region is more than 0.6.

### 9. Evaluation Results

The evaluation results are shown in the table of FIG. 3. From the results, it is understood that an image having both the friction fastness and black color development property can be formed by using the ink set of the present embodiment.

What is claimed is:

1. An ink jet ink set comprising:
a first ink jet ink; and
a second ink jet ink, wherein
the first ink jet ink contains a first pigment containing a black pigment, a first binder resin containing an anionic urethane resin particle, an organic solvent, and water,
the first pigment is contained in an amount of 3% by mass or more based on a total amount of the first ink jet ink,
the anionic urethane resin particle is contained in an amount of 5% by mass or more based on the total amount of the first ink jet ink,
the anionic urethane resin particle is an only resin particle contained in a largest amount in the first binder resin,
the second ink jet ink contains a second pigment containing at least one selected from the group consisting of a black pigment and a blue pigment, a second binder resin containing an anionic acrylic resin particle, an organic solvent, and water,
the second pigment is contained in an amount of 3% by mass or more based on a total amount of the second ink jet ink,
the anionic acrylic resin particle is contained in an amount of 3% by mass or more based on the total amount of the second ink jet ink, and
the anionic acrylic resin particle is an only resin particle contained in a largest amount in the second binder resin.

2. The ink jet ink set according to claim 1, wherein
the first ink jet ink has a pH of 8 to 11 at 25° C., and
the second ink jet ink has a pH of 8 to 11 at 25° C.

3. The ink jet ink set according to claim 1, wherein
the first binder resin is contained in an amount of 10% by mass or less based on the total amount of the first ink jet ink, and
the second binder resin is contained in an amount of 10% by mass or less based on the total amount of the second ink jet ink.

4. The ink jet ink set according to claim 1, wherein
the blue pigment contains C.I. Pigment Blue 15:3.

5. The ink jet ink set according to claim 1, wherein
a sum of the amounts of the first pigment and the first binder resin is 13% by mass or less based on the total amount of the first ink jet ink, and
a sum of the amounts of the second pigment and the second binder resin is 13% by mass or less based on the total amount of the second ink jet ink.

6. The ink jet ink set according to claim 1, wherein
the ink jet ink set is for textile printing.

7. The ink jet ink set according to claim 1, wherein
the black pigment is a self-dispersible carbon black.

8. The ink jet ink set according to claim 1, wherein
the blue pigment is a polymer-dispersible pigment.

9. An ink jet recording method comprising:
using the ink jet ink set according to claim 1;
attaching the first ink jet ink to a recording medium by ejecting the first ink jet ink using an ink jet method; and
attaching the second ink jet ink to the recording medium by ejecting the second ink jet ink using an ink jet method, wherein
the attaching the first ink jet ink and the attaching the second ink jet ink are performed on a same region of the recording medium.

10. The ink jet ink recording method according to claim 9, wherein
an ink attachment amount in the attaching the first ink jet ink is 13 mg/inch² or more and,
an ink attachment amount in the attaching the second ink jet ink is 13 mg/inch² or more, and
a sum of the ink attachment amount in the attaching the first ink jet ink and the ink attachment amount in the attaching the second ink jet ink is 26 to 40 mg/inch².

11. The ink jet recording method according to claim 9, wherein
the second pigment contains the blue pigment, and
the ink attachment amount in the attaching the first ink jet ink is larger than the ink attachment amount in the attaching the second ink jet ink.
